(19) United States
(12) Patent Application Publication
(10) Pub. No.: US 2006/0117257 A1
(43) Pub. Date: Jun. 1, 2006

(54) System and method for processing JavaScript resource files

(75) Inventors: Laurent D. Hasson, New York, NY (US); Kaushal S. Kurapati, Yorktown Heights, NY (US); Jianren Li, Valhalla, NY (US)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 11/000,270

(22) Filed: Nov. 30, 2004

(51) Int. Cl. G06F 17/24

(52) U.S. Cl. 715/535

(57) ABSTRACT

A system and method that locates and utilizes JavaScript national language resource files. A national language processing system for providing national language specific resources to be displayed in the Web page, including: a Web resource manager for providing a location of a JavaScript national language resource, wherein the Web resource manager includes a hash table for storing and querying previously located JavaScript national language resources; and a system for issuing an http request to a server to locate the JavaScript national language resource if the location of the JavaScript national language resource does not exist in the hash table.

### BACKGROUND OF THE INVENTION

1. Field of the Invention

The present invention generally relates to processing national language dependent Web pages, and more particularly relates to a method, system, and computer program product for locating JavaScript national language resource files from Odyssey Browser Framework (OBF) enabled Web pages.

2. Related Art

The Web has created an incredible growth environment by making business applications easy to deploy, manage, and access. As such, it has displaced the client-server model fairly quickly. Based on open standards such as Java, J2EE, HTTP, HTML and JavaScript, and the ubiquitous browser, enterprises have been able to open up their “backends” and create an environment where employees and customers can access a variety of applications from anywhere, at any time.

On the other hand, the Web has created a user experience that is considered quite universally as a step backward from what existed previously in the client-server world. There, clients enjoyed arbitrary richness as provided by the hosting GUI-based operating system such as Microsoft's Windows. Although Web interfaces can be made very graphical, the actual interactivity model is very restrictive. The perceptible performance gap and full screen refreshes for instance between most interactions with the user remain an issue. ActiveX controls and Applets attempt to remedy this in various ways but have failed to gain a ubiquitous usage because of issues including the development model, security, performance and compatibility. Only the Web page with HTML, DHTML, CSS and JavaScript, and to some extent Macromedia Flash, has remained ubiquitous and widely used.

The Odyssey Browser Framework (OBF) tries to address many of the interactivity issues raised by the Web, but remains rooted in the traditional Web page architecture. Based on an advanced usage of JavaScript (which we like to think of as Smalltalk with a C-like syntax) in modern browsers such as IE 5.5 and above, Netscape 6 and above, and Mozilla 1.x, the Odyssey Browser Framework seeks to create “Web pages that last longer.” Composed with a dynamic model that packs more data, Odyssey enabled Web pages are able to sustain longer interactions with the end user without requiring roundtrips back to the server. By creating what effectively is an MVC (Model View Controller) model inside the page, a developer is able to define a working data set and a set of controls that dynamically bind to that data. The user can then interact with the working data set, using those controls, and until a roundtrip back to the server is really necessary (e.g., to submit data, complete a transaction etc.), the user benefits from response times and a freedom to interact with the page that is uncommon in regular Web pages.

The core base library upon which OBF is based is written in JavaScript and is called JSL (JavaScript Library). The JSL is a complex JavaScript library that enables a developer to create a full MVC on the Web page. It implements a model using a JavaScript implementation of core classes in EMF (the Eclipse Modeling Framework, available at http://www.eclipse.org/emf). Some of the JavaScript resource files are message files that enable national language specific labels and messages to be displayed in Web pages. Depending on the language setting of the browser (e.g., English-US: en_US or French-France: fr_FR), the appropriate labels/messages are displayed on the page. This complies with NL (National Language) requirements for IBM Products that are marketed and sold worldwide.

In Web pages that have been built using the OBF, the developer needs to ensure that the appropriate JavaScript NL message files are included in a particular Web page. For instance, if the browser language setting was fr_FR French-France, only the following one file needs to be included:
(1) OdysseyMessage_fr_FR.js.

Furthermore, if the language setting was en-US, and there is only “en” (i.e., English only, not English-US or English-UK) message files, then the system needs to gracefully fallback and search for “en” files once it has not found any “en-US” files. This graceful degeneration allows the system to default to English if national language specific files are not available for a specific country.

One brute force solution is to blindly include all language message files into the Web page. However, this creates excessive loading times for the Web page that might not be acceptable to users. Moreover, the message label variables carry the same name in all message files, which means that there would be a namespace clash among variable names and this would cause runtime errors. Thus, this solution does not solve the NL-enablement problem.

Another approach is to create NL specific “properties” files, creating equivalent properties files for each JavaScript NL file. Then one could use the standard Java internationalization API, ResourceBundle Oava.util.ResourceBundle→http://java.sun.com/products/jdk/1.2/docs/api/java/util/ResourceBundle.html) to search for the appropriate language properties file. The properties file would contain name value pairs like this “variableName=variableValue,” which would then need to be transformed into proper JavaScript, e.g., var variableName=“variableValue,” which could then be used by the OBF to generate appropriate labels and messages on the Web page. A hash table could be employed to cache the name of the appropriate NL properties file in order to speed up repeated search and transformation operations. The main drawback of this approach is that the name=value pairs in the properties file have to be converted into proper JavaScript variables for use by other OBF controls, which creates a performance bottleneck. This process has to be repeated for every Web page served, and we can not take advantage of browser built-in caching capability as in the case of including file resource.

Moreover, having NL-specific properties files violates the design of building a core library entirely in JavaScript. Thus, existing solutions cannot cater to the requirements of the NL enablement problem in OBF. Accordingly, a need exists for a system and method for enabling national language support in an Odyssey Browser Framework.

### SUMMARY OF THE INVENTION

The present invention addresses the above-mentioned problems, as well as others, by providing a system, method and program product that enables national language support in an Odyssey Browser Framework by issuing a full http request to locate a particular JavaScript (JS) NL resource. (Note that as a substitute to issuing a full http request, a local J2EE API call on server could be made if the data source was local. Accordingly, for the purposes of this invention, it is assumed that such a local call falls within the scope of the process described generically herein as issuing an http request.) If found, the appropriate path to the located JavaScript national language resource is stored in a hash table, which improves future look-up operations. The solution also implements graceful degeneration and defaults to “en” (English) message files if all attempts to locate a particular NL resource file fail.

In a first aspect, the invention provides a national language processing system on server for providing national language specific resources to be displayed in a Web page, comprising: a Web resource manager for providing a location of a JavaScript national language resource, wherein the Web resource manager includes a hash table for storing and querying previously located JavaScript national language resources; and a system for issuing an http request to a server to locate the JavaScript national language resource if the location of the JavaScript national language resource does not exist in the hash table.

In a second aspect, the invention provides a program product stored on recordable medium that allows national language specific resources to be displayed in a Web page, comprising: means for providing a location of a JavaScript national language resource, wherein the providing means includes a hash table for storing and querying previously located JavaScript national language resources; and means for issuing an http request to locate the JavaScript national language resource if the location of the JavaScript national language resource does not exist in the hash table.

In a third aspect, the invention provides a method for including national language specific resources in a Web page, comprising: searching a hash table for a location of a JavaScript national language resource; if the location is found in the hash table, generating an include statement in the Web page; if the location is not found in the hash table, issuing an http request to locate the JavaScript national language resource; if the location is determined by the http request, storing the location in the hash table and generating an include statement in the Web page.

In a fourth aspect, the invention provides a method for deploying an application that includes national language specific resources in a Web page, comprising: providing a computer infrastructure being operable to: determine a location of a JavaScript national language resource by providing a hash table for storing and querying previously located JavaScript national language resources; and issue an http request to locate the JavaScript national language resource if the location of the JavaScript national language resource does not exist in the hash table.

In a fifth aspect, the invention provides computer software embodied in a propagated signal for including national language specific resources in a Web page, the computer software comprising instructions to cause a computer to perform the following functions: search a hash table for a location of a JavaScript national language resource; if the location is found in the hash table, generate an include statement in the Web page; if the location is not found in the hash table, issue an http request to locate the JavaScript national language resource; if the location is determined by the http request, store the location in the hash table and generate an include statement in the Web page.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a system diagram for generating an OBF enabled Web page in accordance with present invention.

FIG. 2 depicts a flow diagram of a method locating JavaScript national language resource files in accordance with present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

JavaScript national language resources contain language specific Web assets (e.g., textual questions) that can be downloaded from a server and displayed on a Web page to an end user. Depending on the particular locale (i.e., language preference) of the browser viewing the page, any one of a plurality of different language versions of the Web asset can be utilized. As noted above, JavaScript national language resources may be identified by a file name that includes a country and language code. For instance, the name format of a resource is typically of the form:

<resource ID>_<language code>_<country code>.js

where “<language code>_<country code>” refers to the user locale. For example, the resource “OdysseyMessage_fr_FR.js” refers to a resource for a user locale consisting of French language in the country of France.

In order to utilize JavaScript national language resource files, the present invention issues a full http request to locate a particular JavaScript national language resource file. If found, the appropriate path to the located NL JavaScript file is stored in a hash table, which speeds up future look-up operations. If the resource is not found, the invention implements a graceful degeneration process that: (1) truncates the country code in the resource name, and (2) defaults to an “en” (generic English) message file if all attempts to locate a particular NL resource file fail.

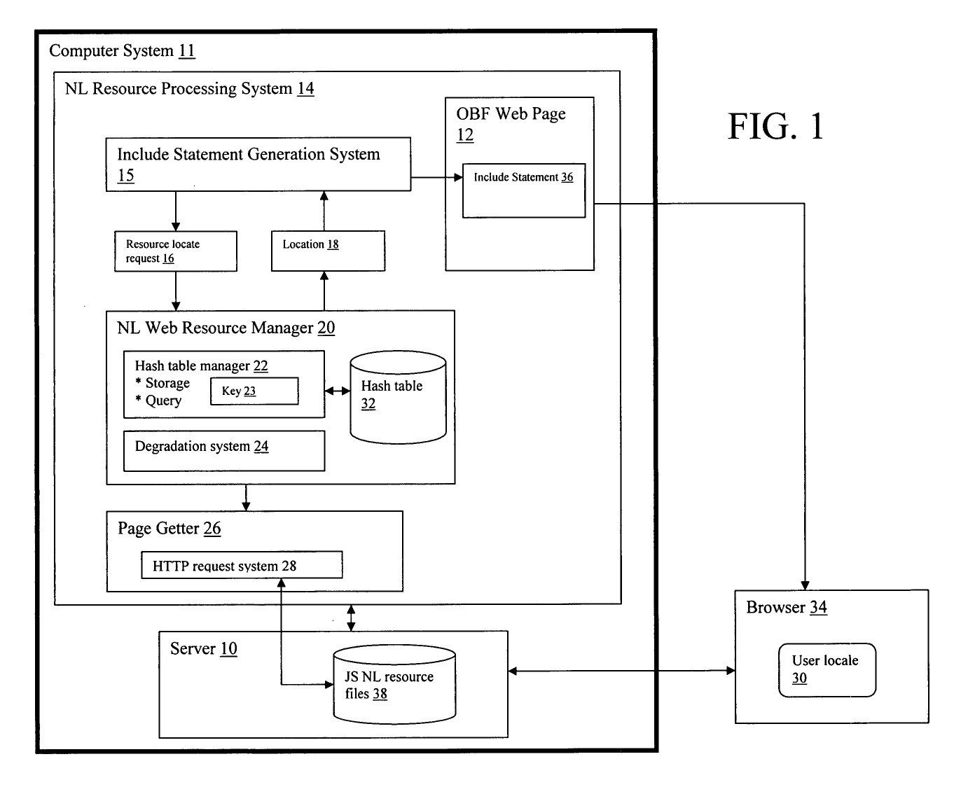

Referring now to FIG. 1, a system diagram is shown comprising a computer system 11 having a server 10 capable of serving an OBF Web page 12 to browser 34. Computer system 11 also includes a national language (NL) resource processing system 14 that enables national language labels and messages to be display on the Web page 12. In particular, depending on the user locale 30, i.e., the language country setting of the browser 34, an include statement 36 will be generated by include statement generation system 15 such that the appropriate language specific message will be displayed whenever a statement in the OBF Web page 12 is encountered that requires an NL based Web asset. For example, consider the statement:

“document.writeln (BIRTHDAY_QUESTION);”

which requires the NL based Web asset BIRTHDAY_QUESTION. Depending on the user locale setting, the statement should appear to the user in the Web page as, e.g., “Please enter your birth date” for English, “Entrez votre date de naissance s'il vous plait” for French, etc.

To provide this functionality, the present invention stores the necessary message or Web assets on the server 10 as JavaScript national language resource files 38. For instance, the Web assets may be stored as follows:

Resource.en_US.js

var BIRTHDAY_QUESTION=“Please enter your birth date”

Resource.fr_FR.js

var BIRTHDAY_QUESTION=“Entrez votre date de naissance s'il vous plait”etc. When the statement “document.writeln (BIRTHDAY_QUESTION);” is encountered, NL resource processing system 14 transforms the statement into:

include “Resource.en_US.js”;

document.writeln (BIRTHDAY_QUESTION);

if the user locale 30 was en_US, and

include “Resource.fr_FR.js”;

document.writeln (BIRTHDAY_QUESTION);

if the user locale 30 was fr_FR, etc.

In order to generate the necessary include statement 36, the appropriate JavaScript national language resource file must be located. Locating the resource files is handled by NL Web Resource Manager 20 and Page getter 26, which can be implemented as Java classes as described below.

NL Web Resource Manager 20 takes as input a resource locate request 16 comprised of a locale string (e.g., “en_US”), base file name (e.g., OdysseyMessage), and base URL (e.g., http://ServerName:PortNumber/contextroot) and returns a location 18, i.e., the path to the JavaScript national language resource file at server 10. The server name, port number and context root required to construct the base URL are provided to the NL Web Resource Manager 20. Server name and port number are retrieved from a servlet request, (e.g., servletRequest.getServerName( ) and servletRequest.getPortNumber( )). Context root is obtained from an http servlet request (e.g., httpReq.getContextPath( )). Once the base URL is constructed, the resource location 18 is either ascertained by querying a hash table 32, or by a full search performed by page getter 26. Once the location 18 is determined, include statement generation system 15 generates the appropriate include statement 36 in the OBF Web page 12.

Hash table 32 is created in the class by the hash table manager 22 and provides a cache in which data can be quickly stored and received. When a path is located using a full http search, hash table manager 22 stores the path with a key 23 to the hash table 32. In one illustrative embodiment, the key 23 may comprise a string of the form “base file name+locale.” The first time a resource is required, the hash table 32 will be empty, and a full search for the appropriate JavaScript national language resource file takes place using page getter 26. Once found, a key 23 is generated and the relative path to the located JavaScript national language resource file is stored in the hash table 32. Upon future requests to locate JavaScript national language resource files 38, hash table manager 22 can first query the hash table 32 with the appropriate key 23 (i.e., base file name+locale string). In this manner, the corresponding relative path to the JavaScript national language resource file can be retrieved instantaneously, avoiding a full search via page getter 26.

When the location of the resource does not exist in the hash table 32, NL Web Resource Manager 20 must use page getter 26 to issue a full http request via HTTP request system 28 to locate the required JavaScript national language resource file. Note that while the JavaScript national language resource files 38 are shown as part of server 10, these files, may reside externally to both server 10 and computer system 11. Note that as an alternative to issuing a full http request, a local J2EE API call on server could be made if the source was local. Accordingly, for the purposes of this invention, it is assumed that such an alternative falls within the scope of the process described generically herein as issuing a full http request. If the full http request is not successful, page getter 26 throws an exception and NL Web Resource Manager 20 implements degradation system 24 which attempts to locate another NL resource with a degenerated locale string.

In particular, degradation system 24 first truncates the user locale 30 to eliminate the country code (e.g., filex_fr_FR.js would be truncated to filex_fr.js). NL Web Resource Manager 20 then attempts to locate the truncation version of the file (either in the hash table 32 or by page getter 26). If the truncated version is found, its location is returned to NL Web Resource Manager 20. If the truncated version of the JavaScript national language resource file is not found, then degradation system 24 defaults to searching for a generic English version “en” resource file, e.g., filex_en.js.

A feature of the present invention is that by providing a mechanism that adds a national language resource file include statement 36 into the Web page 12, the built-in caching capability of the browser 34 is taken advantage of. In particular, when a user interacts with the server 10 via browser 34, a given resource file only needs to be downloaded to the browser 34 once. If another page requires the same resource file, the browser 34 will simply load the resource file from the cache of the local machine. Using this technique, lighter network traffic can be achieved and thus provide better performance.

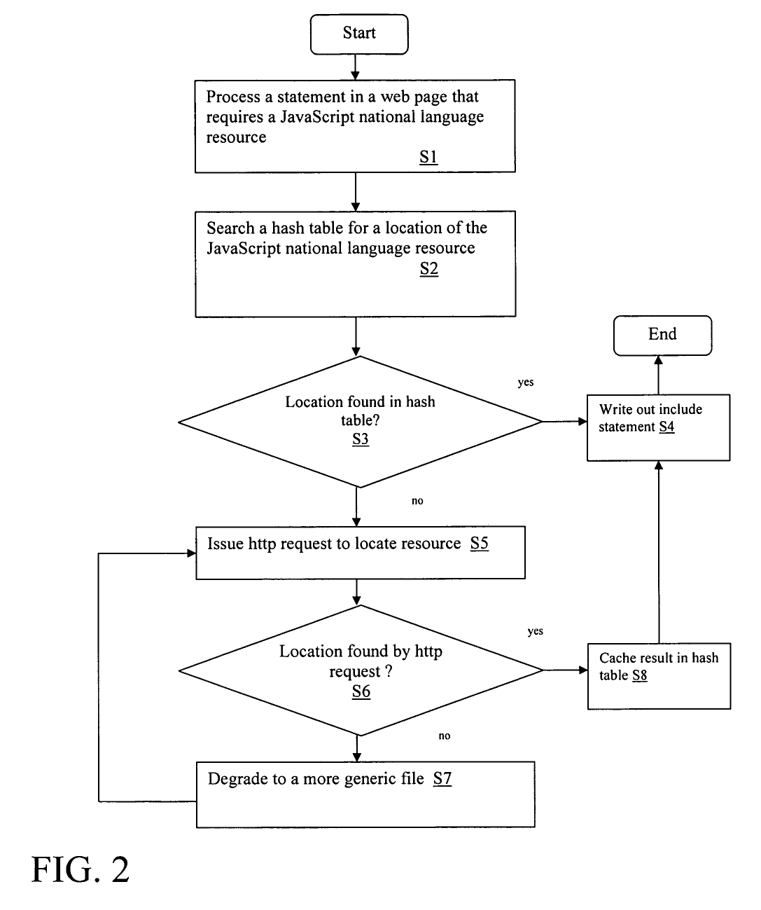

Referring now to FIG. 2, a flow diagram of a method of implementing the present invention is shown. At step S1, a statement in the Web page is processed that requires a JavaScript national language resource. Next, at step S2, a hash table is searched (i.e., queried) for a location of the JavaScript national language resource. At step S3, a determination is made whether the location was found in the hash table. If the location was found in the hash table, then the include statement is written out at step S4, and the process ends. If the location was not found in the hash table, then at step S5, an http request is issued to locate the resource. At step S6, a determination is made whether the location was found by the http request. If the location of the resource was found at step S6, the result is cached at step S8, the include statement is written out at step S4, and the process ends. If it was not found, the process degrades to search for a more generic file at step S7. As noted above, degradation involves first truncating the resource name, e.g., fr_FR to fr, and repeating steps S5 and S6. If the truncated version of the resource was also not found, the degradation process defaults to a generic English version, e.g., “en,” and steps S5 and S6 are again repeated.

It should be appreciated that while the present invention is described with reference to locating JavaScript national language resource files 38 in an odyssey browser framework environment, the inventive techniques described herein could be applied to any client-based process that requires server-based resources.

It should also be understood that computer system 11 may comprise any type of computer, e.g., workstation, laptop, handheld device, PDA, cell phone, smart appliance, etc. Although not shown, computer system 11 may include a processor, memory, a bus, input/output (I/O) interfaces and external devices/resources. The processor may comprise a single processing unit, or may be distributed across one or more processing units in one or more locations. Memory may comprise any known type of data storage and/or transmission media, including magnetic media, optical media, random access memory (RAM), read-only memory (ROM), etc. Moreover, similar to the processor, the memory may reside at a single physical location, comprising one or more types of data storage, or be distributed across a plurality of physical systems in various forms.

I/O interfaces may comprise any system for exchanging information to/from an external source. External devices/resources may comprise any known type of external device, including speakers, a CRT, LED screen, handheld device, keyboard, mouse, voice recognition system, speech output system, printer, monitor/display, facsimile, pager, etc. The bus provides a communication link between each of the components in computer system, and likewise may comprise any known type of transmission link, including electrical, optical, wireless, etc. In addition, although not shown, other components, such as cache memory, communication systems, system software, etc., may be incorporated into computer system 11.

NL resource processing system 14 may be stored in the computer system memory, such that the functional components are provided as a computer program product. It should be appreciated that the teachings of the present invention can be offered as a business method on a subscription or fee basis. For example, NL resource processing system 14 could be created, maintained, supported, and/or deployed by a service provider that offers the functions described herein for customers. That is, a service provider could be used to provide OBF Web pages, as describe above.

It should also be understood that the present invention can be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A national language processing system for providing national language specific resources to be displayed in a Web page, comprising:
a Web resource manager for providing a location of a JavaScript national language resource, wherein the Web resource manager includes a hash table for storing and querying previously located JavaScript national language resources; and
a system for issuing an http request to a server to locate the JavaScript national language resource if the location of the JavaScript national language resource does not exist in the hash table.

2. The national language processing system of claim 1, further comprising a degradation system that attempts to locate a truncated version of the JavaScript national language resource if an original version of the JavaScript national language resource was not located.

3. The national language processing system of claim 2, wherein the degradation system defaults to a generic English version of the JavaScript national language resource if both the original version and truncated version were not located.

4. The national language processing system of claim 1, further comprising a include statement generation system for transforming a resource dependent statement in the Web page to comprise an include statement, wherein the include statement specifies a required version of the JavaScript national language resource.

5. The national language processing system of claim 1, wherein the Web resource manager takes as input a locale, a base file name, and a base uniform resource locator (URL), and outputs a relative path to the natural language JavaScript resource file.

6. The national language processing system of claim 5, wherein the base URL is constructed from a server name, port number and context root, which are obtained by issuing servlet requests.

7. The national language processing system of claim 1, wherein the Web resource manager utilizes a key to store and query location data in the hash table, and wherein the key comprises a string that includes a base file name and a locale.

8. A program product stored on recordable medium that allows national language specific resources to be displayed in a Web page, comprising:
means for providing a location of a JavaScript national language resource, wherein the providing means includes a hash table for storing and querying previously located JavaScript national language resources; and
means for issuing an http request to locate the JavaScript national language resource if the location of the JavaScript national language resource does not exist in the hash table.

9. The program product of claim 8, further comprising means for attempting to locate a truncated version of the JavaScript national language resource if an original version of the JavaScript national language resource was not located.

10. The program product of claim 9, further comprising means for defaulting to a generic English version of the JavaScript national language resource if both the original version and truncated version were not located.

11. The program product of claim 8, further comprising means for transforming resource dependent statements in the Web page to comprise an include statement, wherein the include statement specifies a required version of the JavaScript national language resource.

12. The program product of claim 8, wherein the providing means takes as input a locale, a base file name, and a base uniform resource locator (URL), and outputs a relative path to the natural language JavaScript resource file.

13. The program product of claim 12, wherein the base URL is constructed from a server name, port number and context root, which are obtained by issuing servlet requests.

14. The program product of claim 8, wherein the providing means utilizes a key to store and query location data in the hash table, and wherein the key comprises a string that includes a base file name and a locale.

15. A method for including national language specific resources in a Web page, comprising:
searching a hash table for a location of a JavaScript national language resource;
if the location is found in the hash table, generating an include statement in the Web page;
if the location is not found in the hash table, issuing an http request to locate the JavaScript national language resource;
if the location is determined by the http request, storing the location in the hash table and generating an include statement in the Web page.

16. The method of claim 15, comprising the further step of:
searching for a truncated version of the JavaScript national language resource if an original version was not found by the http request.

17. The method of claim 16, comprising the further step of:
searching for a generic English version of the remotely located JavaScript national language resource if both the original and truncated versions were not found.

18. The method of claim 15, wherein the step of searching the hash table includes the step of using a key that comprises a string which includes a base file name and a locale.

19. A method for deploying an application that includes national language specific resources in a Web page, comprising:
providing a computer infrastructure being operable to:
determine a location of a JavaScript national language resource by providing a hash table for storing and querying previously located national language JavaScript resources; and
issue an http request to locate the JavaScript national language resource if the location of the JavaScript national language resource does not exist in the hash table.

20. Computer software embodied in a propagated signal for including national language specific resources in a Web page, the computer software comprising instructions to cause a computer to perform the following functions:
search a hash table for a location of a JavaScript national language resource;
if the location is found in the hash table, generate an include statement in the Web page;
if the location is not found in the hash table, issue an http request to locate the JavaScript national language resource;
if the location is determined by the http request, store the location in the hash table and generate an include statement in the Web page.
